(19) United States
(12) Patent Application Publication
(10) Pub. No.: US 2007/0055560 A1
(43) Pub. Date: Mar. 8, 2007

(54) Document creation and review system, method and apparatus

(76) Inventor: Eugene R. Quinn JR., Syracuse, NY (US)

Correspondence Address: Eugene R. Quinn, Jr., 400 Brattle Road, Syracuse, NY, 13203, US

(21) Appl. No.: 11/509,913

(22) Filed: Aug. 25, 2006

Related U.S. Application Data
(60) Provisional application No. 60/711,984, filed on Aug. 26, 2005.

(51) Int. Cl. G06Q 99/00; G05B 19/418; G06F 9/46

(52) U.S. Cl. 705/8; 705/1

(57) ABSTRACT

A problem faced by many businesses is a lack of resources necessary to hire competent professional assistance. This is particularly problematic for individuals, inventors, sole proprietors, entrepreneurs, start-ups and small businesses. The present invention advantageously enables the professional review of any number of different types of documents, including but not limited to: patent, trademark and copyright applications, business plans, incorporation agreements, governance documents, white papers, marketing reports, quarterly and annual reports, tax returns, employment agreements, non-compete agreements, intellectual property agreements and assignments, licenses, confidentiality agreements and employment contracts, and employee handbooks and policies. Furthermore, the present invention also allows for the professional review to be relatively quick, competent and thorough. Still further, because in certain embodiments the present invention is semi-automated it can be operated by one of average intelligence while at the same time not compromising the integrity and quality of the overall professional review.

### CROSS REFERENCE TO RELATED APPLICATION

This application claims the benefit of earlier priority based upon the filing of a provisional application, Ser. No. 60/711,984, which was filed on Aug. 26, 2005.

### BACKGROUND OF THE INVENTION

1. Field of the Invention

This invention relates generally to a universal interactive semi-automated document review system, method and apparatus.

2. Background

There are many types of documents that need to be created in a business setting. These documents include patent applications, trademark applications, copyright applications, business plans, incorporation agreements, governance documents (such as bylaws, for example), white papers, marketing reports, quarterly and annual reports, tax returns, employment agreements, non-compete agreements, intellectual property assignments, intellectual property agreements, licenses, confidentiality agreements and employment contracts, employee handbooks, and sexual harassment policies to name but a few.

Those who perform management functions and responsibilities in the corporate world (i.e., Chief Executive Officer, Managing Partner, Managing Member, Sole Proprietor, etc.), are rarely if ever experts in each and every aspect of running a business. Given that those who operate businesses are not experts in all facets of their businesses it is necessary to seek outside, professional assistance in many situations. Indeed, it is not uncommon for large corporations to employ a law firm to handle all legal work (such as mergers, acquisitions, patents, employment matters, contract drafting, etc.). Likewise, it is not uncommon for large corporations to employ accountants, financial planners, business development consultants, marketing firms, public relations experts, to name but a few.

One of the unique problems faced by most if not all businesses is a lack of financial and/or other resources necessary to hire and/or otherwise retain competent professional assistance. This is particularly problematic for sole proprietors, entrepreneurs, start-ups and small businesses because during the early developmental and growth stages financial resources are frequently quite limited.

Given the limitations of financial and other resources many sole proprietors, entrepreneurs, start-ups and small businesses are forced to do much if not all of their own drafting work, including drafting the multitude of documents that are required and/or desired (such as those previously discussed and others known to those skilled in the art). Additionally, for various reasons, individuals employed by even large corporations sometimes find themselves in a setting where drafting work is done in-house.

Even those who are willing to devote the time necessary to do the aforementioned work on their own can be quickly lost in the maze of nuances that trained professionals spend a lifetime learning to navigate.

There are numerous “self-help” or “how to” books available to individuals who find it necessary to do their own drafting. One of the more popular of these books is titled “Patent It Yourself”, which is published by Nolo.com and as of April 2004 was in its 10^{th} edition. Nolo.com also publishes other “self-help” or “how to” books directed to the business side of drafting documents, for example “How to Write a Business Plan”, which as of December 2004 was in its 7^{th} edition.

Certainly, Nolo.com is not the only publisher of such “self-help” or “how to” books. Indeed, a Google search, a search of Amazon.com, or a search of any real world brick and mortar bookstore such as Barnes & Noble, Books A Million or Borders will undoubtedly uncover numerous “self-help” and “how to” books that are particularly aimed at inventors, entrepreneurs, start-ups, small businesses and businesses in general.

In addition to the numerous “self-help” and “how to” books available, there are also software packages available that will assist individuals in drafting patent applications, and still other software packages are available to assist in drafting business plans and other business related forms, documents and reports.

These previously mentioned books are normally not outrageously priced and the software packages while significantly more are still not normally unreasonably highly priced. The byproduct of such availability and pricing is that many individuals, for various reasons and given various circumstances and resources, turn to these outlets in search of answers and will, in fact, choose to do their own document drafting.

Even though some of the available sources can be quite informative, in any document, whether a patent application, a business plan or any other kind of business document, there are innumerable nuances that need to be taken into account. While there can be some standardization in certain types of documents in some instances, in order to be complete, effective and worthwhile the documents that are necessary for a business must be tailored for each unique situation.

The primary problem with the available “self-help” and “how to” sources (i.e., books and software) is that they only provide passive information. There is no ability to interact with the source in a way that allows for value added input to be delivered by a trained professional.

Of course, the very fact that “self help” and “how to” sources exist owes itself to the fact that value added input delivered by trained professionals can be, and frequently is, quite expensive. In the patent context the average hourly billing rate of patent attorneys in the United States is over $250 per hour. For patent attorneys working in major cities this number can be significantly higher. Furthermore, this national average represents the average for all attorneys, whether they have less than 1 year of experience or many years of experience. In the entrepreneurial or start-up situation many issues that will be confronted are cutting edge and/or at the very least may require significant time invested on the part of an experienced, senior patent attorney. Purchasing such hourly time from an experienced, senior patent attorney can quickly price many inventors, entrepreneurs, start-ups and small businesses out of the mark. This situation likewise holds true in the business consulting, business planning, tax, accounting and marketing segments. Where consultation is required market price works to price those who most need the service out of the market.

Moreover, given the cost consciousness of many large corporations many types of drafting work is at least initially conducted in-house, or project billing rates (sometimes referred to as flat fees) are obtained. Project billing, however, creates a disincentive for the attorney or other business professional to engage in the most complete and thorough representation. This is true because the attorney or other business professional will receive the same compensation regardless of the amount of time actually spent on a particular application or project. In essence, even large corporations who are allegedly purchasing unlimited attorney time in the form of project billing arrangements could be better served if their were a mechanism in place that would allow for in-house individuals to do the initial drafting while also having the opportunity to receive meaningful, tailored, value added input from a trained professional. Again, although this problem has so far been largely defined specifically in terms of legal services, the story is much the same with respect to other business consulting professionals, and value added input from trained professionals would be equally advantageous.

Similarly, there is also a need to create a mechanism whereby individuals can initially draft legal and other documents on their own (such as wills, trusts, living wills, powers of attorney, divorce papers, bankruptcy papers, child custody papers, landlord-tenant contracts/documents, real estate agreements/documents and any other type of legal or professional document that may be encountered) and obtain value added input from a trained professional. Such a mechanism would enable individuals to reap the cost savings associated with do-it-yourself work, while at the same time reap the rewards of being able to meaningfully and cost effectively consult with trained professionals. In short, while much of this application is directed toward business embodiments there is absolutely no reason why such a system could not also be implemented so as to provide the same or similar type of assistance to individuals in need of various letters or documents. Therefore, it should be understood that document review for individuals facing everyday, non-business situations is within the scope of this invention.

As can be seen, there is presently a vicious cycle. Those who cannot afford to hire a professional (or who voluntarily or involuntarily choose cost saving measures over outsourcing) turn to “self help” and “how to” sources. Those individuals frequently find themselves overwhelmed by the volume of information that must be digested. Given that hiring a consultant has been ruled out (whether due to lack of finances, cost cutting concerns or otherwise), the do-it-yourself individual or entity again turns to additional “self help” and “how to” sources. In some cases this cycle can become so overwhelming that individuals get frustrated and either give up or fall prey to one of the many invention submission or business promotion companies operating in this market segment. It is exactly this situation that allows such scam submission and promotion companies to prey on the unsuspecting. Exacerbated by the enormity of going it alone the do-it-yourself individual or entity may turn to these scam submission and promotion companies who promise to deliver on enormous promises, but in reality leave customers with little or nothing. This scam has been well documented by the United States Federal Trade Commission and several watchdog groups operating on the Internet.

Additionally, the do-it-yourself individual or entity will also frequently turn to sources of forms either in CD Rom, DVD Rom, in paper or book format or online. These forms can be quite helpful in some circumstances, but as any trained professional in any area knows each document should, in the best case scenario, be drafted to meet the particular and unique needs of the user. Many people believe that one-size-fits-all when it comes to the preparation of the aforementioned documents, but the truth is that each individual or entity has unique concerns, obligations, desires and goals. If that which makes the individual or entity unique is not considered in the drafting phase it is virtually assured that the resulting document, of whatever kind, will not be as good as it could have been.

Therefore, what is needed in the industry is an affordable, interactive system that allows individuals, entrepreneurs, start-ups and businesses to obtain the cost saving, do-it-yourself benefits while at the same time providing meaningful, tailored, helpful input from a trained professional.

### SUMMARY OF THE INVENTION

The present invention advantageously fills the aforementioned deficiencies in the prior art by providing a universal interactive professional document review system, method and apparatus.

The present invention advantageously enables the professional review of any number of different types of documents. Furthermore, the present invention also allows for the professional review to be relatively quick, competent and thorough. Still further, the present invention, because it is semi-automated in the preferred embodiment, can be operated by any person of average intelligence while at the same time not compromising the integrity of the overall professional review. This feature is one of the most unique and exciting aspects of the present invention. The key to scaling the professional review is in the fact that do-it-yourself individuals and entities, who are normally not specifically trained in the particular area where they are attempting do-it-themselves, will routinely and predictably make the same or similar mistakes repeatedly. For this reason it is possible to semi-automate the review system. Detailed comments with explanations, analysis, questions and examples can be created in advance. Much, if not all, of the review then becomes looking for the mistakes that are made, selecting the appropriate comment (which can be a comment question, analysis and/or example) and somehow inserting the comment at or near the appropriate location in the document so as to identify for the do-it-yourself drafter the concern, issue or problem. If, for example the draft document is created in a word processing-program, such as Microsoft Word, comments, questions, analysis, examples, etc. could be inserted in a footnote and/or in the familiar “bubble-like” comment box that routinely appears in the margin when a comment, addition or deletion is made. Additionally, comments can also be placed in end notes or at the end of the document itself. Such end notes or comments at the end or on a separate sheet are most helpful for general comments that pertain to the entire document. These general comments are perhaps most appropriate when something is missing completely or in part. Because many of these general comments are directed to what is missing or not adequately addressed any person of average intelligence can identify what is missing and insert previously formulated comments, which can be of course supplemented by editing the previously formulated-comments to more directly tailor the comment and/or by inserting originally comments.

An illustration of a single, specific example should assist comprehension of the present invention. For example, in a patent application it is quite common for an inventor to describe the invention in very specific terms, leaving out any discussion of other alternatives that would work. By doing this the inventor/applicant is unnecessarily limiting the scope of the protection that could be ultimately obtained. Patent law allows inventors to not only capture that embodiment that works best, but any embodiment that works, no matter how crudely. This is critical because in a patent application you want to describe your invention not only in terms of what works best, but also in terms of what works at all. If your invention becomes a success there will be others who will seek to legally copy your invention, which means they will do what you leave uncovered. For this reason the inventor should describe not only the required parts/configuration of the preferred invention (i.e., best mode), but should describe in detail as many alternative configurations as possible. This is a critical question because that is the question that copyists will ask themselves. Inventors/applicants should describe not only what you want to do, but also what the copyist would likely want to try to get around the resulting patent. When an inventor describes his or her invention in what appears to be highly specific terms, or at least in terms that do not appear to be as broad as possible, a comment or question can be inserted explaining the importance of describing all possible alternatives and perhaps encouraging the inventor/applicant to think outside the box and to try and put themselves in the position of one trying to engineer around their own invention. By pointing this out it provides the inventor/applicant the ability to understand the potential ramifications of what they have drafted, while encouraging them to describe/write in a way that will lead to greater rights and better, stronger, broader protection. Because the professional/reviewer is inserting comments, questions, analysis and/or examples that have been previously created, it is possible to both meaningfully provide value added information and/or analysis, while at the same time keeping the cost of the review low, primarily by keeping down the time each review takes. Of course, in other embodiments it is possible to not only include previously created comments, questions, analysis and/or examples, but to also include some specific, tailored and/or original comments, questions, analysis, examples and/or suggestions. By tailoring previously created comments and/or by inserting original comments, for example, the entire review becomes more meaningful in terms of value added for the do-it-yourself drafter.

In certain embodiments, the present invention also advantageously allows for reviewers and/or work product to be automatically graded so as to determine whether any given review and/or report falls within a predetermined level of acceptability.

In one embodiment of the present invention a draft document will be obtained by a reviewer. The reviewer, who can be anyone of average intelligence, but preferably a trained professional, will read the document. While reading the document the reviewer will seek to identify certain common mistakes that are frequently present in the work product of a do-it-yourself drafter. When a mistake is found a predetermined comment drafted by a highly trained professional (i.e., a person of skill in the art of drafting the type of document in question) will be inserted, preferably at the precise location where the mistake has been made. In order to accomplish such precise insertion a footnote, endnote or some offset or otherwise identifiable review comment text (distinguishable from the text format used by the do-it-yourself drafter in the draft document submitted) may be utilized. These so-called pin-point comments are intended to assist the do-it-yourself drafter identify mistakes (or potential mistakes) that were actually made. These pin-point comments can be predetermined and ready for insertion because in virtually any document there are a number of frequently made mistakes that novice drafters will make. These mistakes of commission normally stand out and are quite easily identifiable when seen by trained professionals and others who are trained to recognize such mistakes (or potential mistakes). Given the finite number of these types of regular mistakes of commission it is also possible train anyone of average intelligence to identify and appropriately respond to such mistakes by inserting a comment.

In another embodiment of the present invention, once the reviewer has completed reviewing the document a series of questions will be asked of the reviewer. These questions are in many ways similar to basic reading comprehension questions, but obviously will be tailored to the specific document being reviewed. These questions will require the review to consider whether the do-it-yourself drafter has included discussion of those types of things that normally should be discussed, included and/or disclosed. These so-called general review comments are preferably intended to assist the do-it-yourself drafter identify things that are missing and/or incomplete.

In another embodiment of the present invention both of the aforementioned pin-point comment review and the general review comments will be utilized together, thereby integrating into a single review comments and professional insight that is intended to provide feedback and/or instruction relative to both mistakes actually made and errors of omission.

In another embodiment of the present invention the do-it-yourself drafter will receive the document containing either or both the pin-point comments and/or the general review comments. The do-it-yourself drafter may elect to make modifications or may leave the document as it was prior to review. In the event that the do-it-yourself drafter elects to make modifications the modified document may be resubmitted for a second review. The benefit of a second review is to provide feedback and/or instruction relative to the modifications made. This is particularly helpful because in attempting to fix errors, whether actually made or errors due to omission, it is quite possible that additional errors of commission or omission may be made. Furthermore, a second review is advantageous because it will give the reviewer a second opportunity to ensure that errors of commission and/or errors of omission are identified, thereby facilitating the presentation of a complete, thorough and professional review.

Of course, any number of iterative reviews can be made of the same document. At some point, however, subsequent reviews will likely be of such marginal value to the do-it-yourself drafter that it will not make sense to continue the review. In the situation where either a first or subsequent review will likely be of marginal value, the reviewer always has the option to refuse to engage in the review. The decision to refuse a review may be based on many factors, perhaps chief among them being the belief that meaningful assistance cannot be provided. This could be due to the fact that one or more reviews have already been completed and there is nothing of value that can be added. Refusal could also be as a result of failure to comprehend the subject matter of the document. If the circumstance leading a reviewer to refuse is a lack of comprehension, the first resort would preferably be to pass the document on to another reviewer or manager who can determine whether there is the individual or collective ability within the universe of available reviewers to provide the requested professional review.

In another embodiment of the present invention the do-it-yourself individual or entity will answer a series of questions. The answers to the questions will be inserted into the professional document to be created or into a template that will create the document in the first instance. The document can then go through the review process previously described. In the patent application situation some or all of the following questions (or variations) can be asked of the do-it-yourself individual or entity:
1. How would you best characterize your invention? (i.e., apparatus, method of making, method of using, composition, etc.) [ABSTRACT]
2. How would you describe your invention in broad general terms? [THEME]
3. How would you describe what your invention does if you had only 10 seconds to describe it to someone? [ABSTRACT]
4. Is there anything else available on the market that is similar? YES or NO
   A. If YES, explain what is deficient, missing, lacking, insufficient, undesirable and/or inferior about that which is similar, but DO NOT describe the other invention or product; and DO NOT use the term “prior art”. [PRIOR ART]
   B. If YES, What makes your invention different than other similar inventions? [SUPERIORITY]
5. What problems does your invention solve or address?
   [INVENTION]
6. Describe all known possible uses for your invention. [KNOWN USES]
7. Describe a single function or feature that consumers will identify as an advantage of your invention (be specific and explain why/how it is an advantage). [ADVANTAGE 1]
8. Is there another function or feature that consumers will identify as an advantage? YES or NO
   If YES, go back to Question 7. [ADVANTAGE 2, etc.]
   If NO, go to Question 9.
9. Describe the single best and most complete way to make your invention. (By best I mean for you to describe the most complete formulation, including any and all options, preferences, bells and whistles). [MAKE BEST]
10. Describe how to make your invention in a way that leaves out all options, preferences, bells and whistles except for those that are absolutely necessary for the invention to work. [MAKE BASIC]
11. Describe the single best and most complete way to use your invention. (By best I mean for you to describe the most complete formulation, including any and all options, preferences, bells and whistles). [USE BEST]
12. Describe how to use your invention in a way that leaves out all options, preferences, bells and whistles except for those that are absolutely necessary for the invention to work. [USE BASIC]
13. Is there another way to make your invention? YES or NO
   A. If YES, describe this alternative way to make your invention and then repeat question 13 until answer is NO. (This description should contain more than the answer to Question 10, but less detail than your answer to Question 9). [MAKE]
   B. If NO go to question 15.
14. Is there another way to use your invention? YES or NO
   A. If YES, describe this alternative way to use your invention and then repeat question 14 until answer is NO. (This description should contain more than the answer to Question 12, but less detail than your answer to Question 11). [MAKE]
   B. If NO go to question 15.
15. In the section titled “Brief Description of the Drawings” you want to have something simple, like “FIG. 1 shows a front view of X.” “FIG. 2 shows a side view of Y.” Etc. etc. each statement is short and declarative, and each gets its own line (i.e., hit return key).
16. How many figures do you have?
17. Describe in words what each figure shows. This should be done with some detail, paying particular attention to the components shown in the figure and how they connect and/or relate to other components also shown. Use reference numerals as you discuss components. [FIGURE DESCRIPTION]
   Repeat for each figure.
19. Who are the inventors? [INVENTORS]
   Answers to these questions, or questions tailored to illicit the same or similar information, are then placed into a patent template. The following template is preferred, although other templates can certainly be utilized:
   {START TEMPLATE}

### [TITLE]

### By [INVENTORS]

### BACKGROUND OF THE INVENTION

Field of the Invention
This invention relates generally to [TITLE]

Background
[PRIOR ART]

Therefore, what is needed is an [TITLE] that does not suffer from the aforementioned problems, and which [INVENTION], and which further [KNOWN USES].

### SUMMARY OF THE INVENTION

The present invention advantageously fills the aforementioned deficiencies by providing [TITLE ] that [INVENTION]. The present invention [SUPERIORITY].

[THEME]

In one particular embodiment of the present invention [MAKE BASIC]. In this particular embodiment the present invention advantageously enables, among other things . . .

In another embodiment of the present invention [MAKE]. In this particular embodiment the present invention advantageously enables, among other things . . .

In still another embodiment of the present invention [MAKE BEST]. In this embodiment the present invention advantageously enables, among other things . . .

In one particular embodiment of the present invention [USE BASIC]. In this particular embodiment the present invention advantageously enables, among other things . . .

In another embodiment of the present invention [USE]. In this particular embodiment the present invention advantageously enables, among other things . . .

In still another embodiment of the present invention [USE BEST]. In this embodiment the present invention advantageously enables, among other things . . .

It is therefore an object of the present invention to provide [ADVANTAGE 1].

It is another object of the present invention to provide [ADVANTAGE 2].

It is a further object of the present invention to provide [ADVANTAGE 3].

It is still further an object of the present invention to provide [ADVANTAGE 4].

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way-of illustration only and so that this disclosure will be thorough, complete and will fully convey the full scope of the invention to those skilled in the art.

### BRIEF DESCRPTION OF THE DRAWINGS

FIG. 1 is a [FIGURE DESCRIPTION]

FIG. 2 is a [FIGURE DESCRIPTION]

FIG. 3 is a [FIGURE DESCRIPTION]

FIG. 4 is a [FIGURE DESCRIPTION]

FIG. 5 is a [FIGURE DESCRIPTION]

FIG. 6 is a [FIGURE DESCRIPTION]

DETAILED DESCRIPTION OF THE INVENTION

The present invention is directed to INSERT TITLE

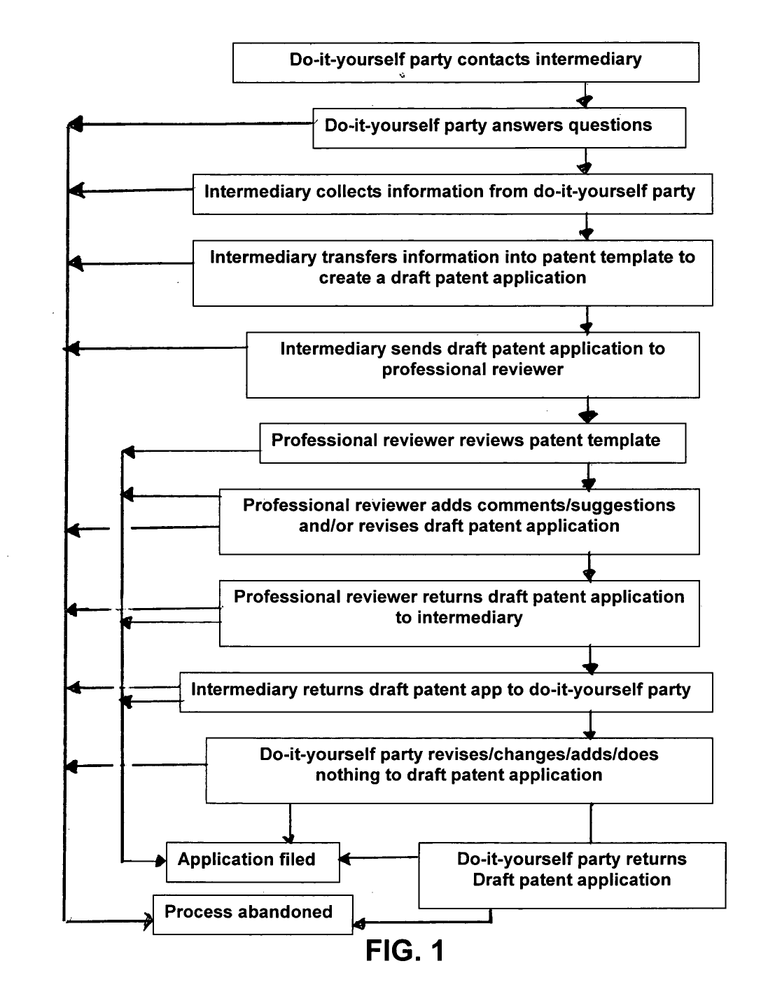

FIG. 1 illustrates . . .

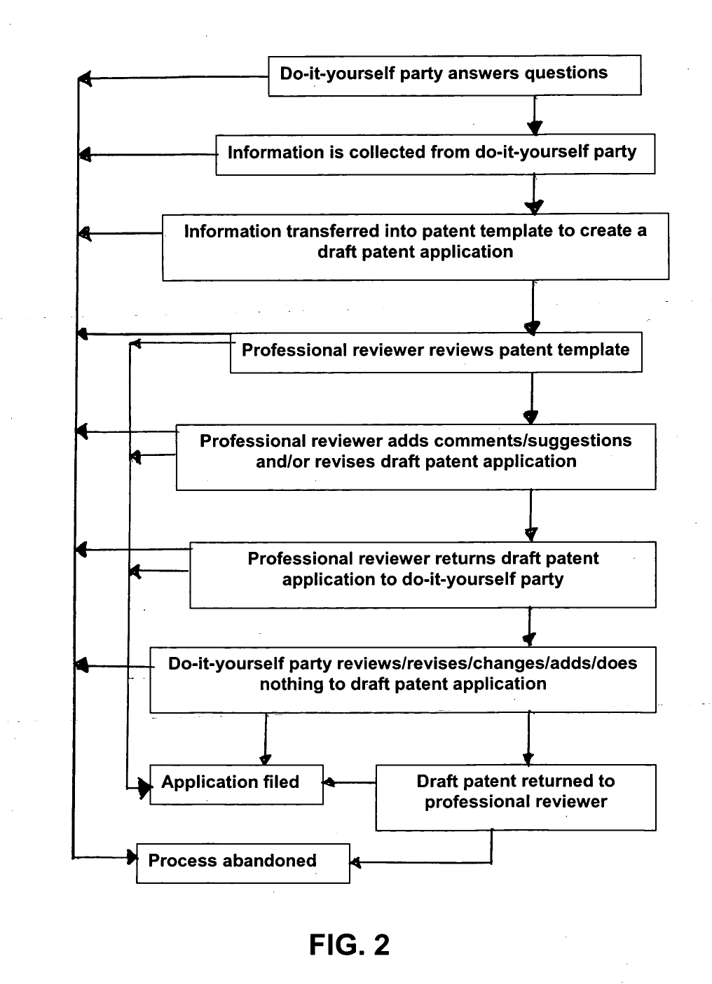

FIG. 2 illustrates . . .

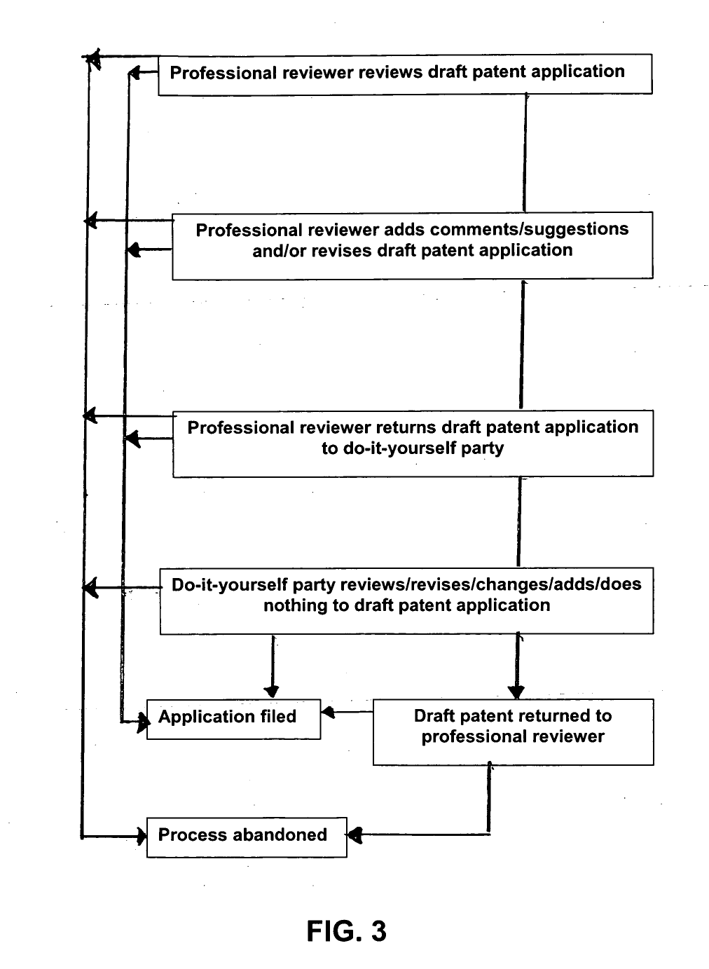

FIG. 3 illustrates . . .

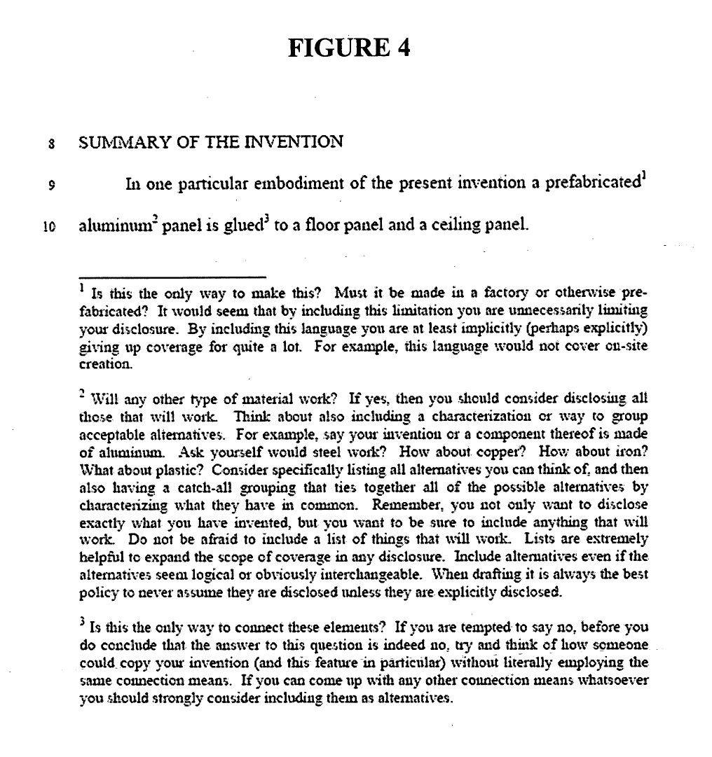

FIG. 4 illustrates . . .

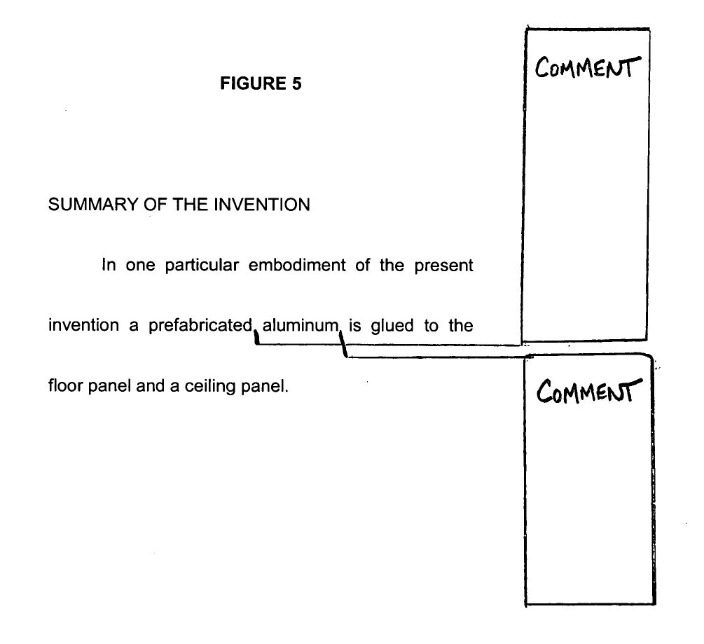

FIG. 5 illustrates . . .

FIG. 6 illustrates . . .

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings. {PAGE BREAK}What is claimed is:

1. A [TITLE] comprising: [FIG. 1 DESCRIPTION].

2. A [TITLE] comprising; [FIG. 2 DESCRIPTION].

3. A [TITLE] comprising: [FIG. 3 DESCRIPTION].

4. A [TITLE] comprising: [FIG. 4 DESCRIPTION].

5. A [TITLE] comprising: [FIG. 5 DESCRIPTION].

6. A [TITLE] comprising: [FIG. 6 DESCRIPTION].

{PAGE BREAK}ABSTRACT

[THEME].
   {END TEMPLATE}

As can be seen from the template above, after the questions are asked and the information inserted into the template there will still be some editing required. In the preferred embodiment this raw template would be returned to the do-it-yourself individual or entity for editing prior to the professional review. Alternatively, prior to returning to the do-it-yourself individual the template could be edited to make the text more coherent. The template can be returned with or without questions or comments or directions. Once the do-it-yourself individual or entity has completed editing the first draft, the new and improved draft is then submitted for professional review, as described above.

As previously mentioned, other templates can certainly be used. Below is a first alternative:

{START TEMPLATE}

### DESCRIPTION

### [INSERT TITLE]

BACKGROUND OF THE INVENTION: (1) Field of the Invention: This invention relates generally to [INSERT TITLE]. (2) Background: That which is available in the market, while perhaps seemingly similar in some ways to the lay observer, is quite different from the present invention. What is lacking in that which is available in the market is [LACKING]. Therefore, what is needed is an [INSERT TITLE] that does not suffer from the aforementioned problems, and which [OBJECTIVES].

SUMMARY OF THE INVENTION: The present invention advantageously fills the aforementioned deficiencies by providing [INSERT TITLE] that [INSERT OBJECTIVES]. The present invention [INSERT SUPERIORITY]. In one embodiment of the present invention [DESCRIBE HOW EMBODIMENT WORKS]. In another embodiment of the present invention [ESCRIBE HOW EMBODIMENT WORKS]. In still another embodiment of the present invention [ESCRIBE HOW EMBODIMENT WORKS]. The present invention will be more fully understood from the accompanying drawings which are intended to be read in conjunction with the description and preferred embodiements.

BRIEF DESCRPTION OF THE DRAWINGS: (1) FIG. 1 is [INSERT DESCRIPTION OF FIG. 1]; (2) FIG. 2 is [INSERT DESCRIPTION OF FIG. 2]; (3) FIG. 3 is [INSERT DESCRIPTION OF FIG. 3].

The present invention consists of the following components: [INSERT COMPONENTS].

DETAILED DESCRIPTION OF THE INVENTION: The present invention is directed to [INSERT TITLE]. [INSERT MAKE & USE]. While the present invention has been described above in terms of certain specific embodiments, it is to be understood that the invention is not limited to these disclosed embodiments. Variations, improvements and/or modifications that would be known to and/or appreciated by someone skilled in the art are within the teachings and scope of the present invention.

{PAGE BREAK}What is claimed is:

1. [INSERT TITLE] comprising: [INSERT HOW COMPONENTS WORK TOGETHER].

{PAGE BREAK}ABSTRACT

The present invention discloses a [INSERT TITLE] that [INSERT HOW WORKS 1.]

{END TEMPLATE}

It is therefore an object of the present invention to provide an affordable, easy to use, interactive system that allows individuals, entrepreneurs, start-ups and businesses to obtain the cost saving, do-it-yourself benefits of document drafting while at the same time providing meaningful, tailored, helpful input from a trained professional.

The present invention will be more fully understood from the accompanying drawings, which are intended to be read in conjunction with both this summary, the detailed description and any preferred and/or particular embodiments specifically discussed.

Other aspects of the present invention are directed to a computer program and an apparatus corresponding to the system and method previously described.

While the present invention has been described in various sections of this application in terms of either preferred and/or specific embodiments, it is to be understood that the invention is not limited to these disclosed embodiments. The preferred and/or specific embodiments are presented here for the purpose of illustration and as an aid to understanding the disclosure contained within. Variations are possible within the teachings of the present invention, and are in fact envisioned and should be envisioned by those of skill in the art. The scope of the invention should be and is intended to be determined by proper interpretation and construction of any claims contained in this disclosure and their legal equivalents, as well as any claims that are and/or can be supported by this disclosure and their legal equivalents.

### BRIEF DESCRPTION OF THE DRAWINGS

FIG. 1 is a flow chart illustrating an exemplary process by which an individual may obtain a professional review.

FIG. 2 is a flow chart illustrating a first alternative process by which an individual may obtain a professional review.

FIG. 3 is a flow chart illustrating a second alternative process by which an individual may obtain a professional review.

FIG. 4 is a portion of a reviewed draft using footnote comments and/or questions.

FIG. 5 a portion of a reviewed draft using the insert comment feature of Microsoft Word.

### DETAILED DESCRIPTION OF THE INVENTION

The present invention relates generally to a universal interactive semi-automated document review system, method and apparatus.

FIG. 1 is a flow chart depicting the initiation of a transaction between the party interested in using one or more of the questions previously described, or similar questions intended to illicit the same information, to create the draft in the first instance (i.e., the do-it-yourself party) and the professional reviewer, through the use of an intermediary responsible for compiling the draft. The steps show in FIG. 1 may, but need not, be implemented through the use of a computer program and/or network.

At the outset, the do-it-yourself party contacts the professional reviewer through the use of an intermediary responsible for compiling the draft. For purposes of this invention generally, and specifically for purposes of the embodiments described in FIG. 1 and FIG. 2 (infra), the do-it-yourself party can be either an individual or an individual working on behalf of an individual or other business entity, such as legal counsel, a business advisors, personal representative, an agent, an independent contractor, a fiduciary and/or an officer, employee or owner of a company. The fact that a representative engages in the process on behalf of an individual or business entity does not change or alter the invention. Furthermore, it is important to realize that while FIG. 1 explains that the intermediary will transfer the information into a patent template and then transmit the patent template to the professional reviewer. While this is the preferred embodiment, it is intended to be and indeed is within the scope of this invention to have the intermediary simply collect the information, transfer the information to the professional reviewer and have the professional reviewer create the draft application using the patent template.

FIG. 2 is similar to what is depicted in FIG. 1, but the embodiment of the invention depicted by FIG. 2 does not employ the use of an intermediary. The contact is initially made with the professional reviewer. After reviewing FIG. 1 and FIG. 2 it should become apparent to one of skill in the art that it is intended to be, and indeed is, within the scope of the invention to allow communications at any stage to bypass an intermediary and proceed directly between the professional reviewer and the do-it-yourself party. Furthermore, the transmission depicted and discussed in FIG. 1 and FIG. 2 preferably occurs via e-mail or other electronic submission, but can be accomplished through a multitude of means, including sending the draft (in hard copy, disk, CD, DVD or other storage medium) in the mail or other courier service (such as UPS, FedEx, DHL or other courier service, including hand delivery courier services). The draft can, however, be sent via facsimile transmission or any other method or means for delivery of the draft to the professional reviewer or an intermediary.

FIG. 3 is a flow chart depicting the initiation of a transaction between the do-it-yourself party (or representative) who does not need to have the professional reviewer or an intermediary create the draft. In this embodiment the do-it-yourself party (or representative) transmits the draft, however created, to the professional reviewer or an intermediary responsible for collecting the draft. This transmission preferably occurs via e-mail or other electronic submission, but can be accomplished through a multitude of means, including sending the draft (in hard copy, disk, CD, DVD or other storage medium) in the mail or other courier service (such as UPS, FedEx, DHL or other courier service, including hand delivery courier services). The draft can, however, be sent via facsimile transmission or any other method or means for delivery of the draft to the professional reviewer or an intermediary.

With respect to FIGs. 1, 2 and 3, it should be clear to those of skill in the art that at any time the process can become abandoned for a variety of reasons, including failure to pay or lack of interest on the part of the do-it-yourself party.

FIG. 4 and FIG. 5 both show a portion of a reviewed draft, which is in this case a reviewed draft patent application (which could also be a provisional patent application). The example in both figures makes several comment mistakes. In FIG. 4 the comments and/or questions are made by use of footnotes, but endnotes could also be used. In FIG. 5 the comments and/or questions are made by use of the familiar insert comment bubble available through Microsoft Word (which in some if not most editions is available under the INSERT menu). It has been discovered that footnotes are normally better to use in reviewing early drafts because the earlier the draft the more likely there will be more comments and/or questions and the more detailed they will likely be. The insert comment method of FIG. 5 does not easily lend itself to verbose comments or questions, particularly when many comments and/or questions are necessary. Nevertheless, the insert comment method of FIG. 5 is a viable option and perhaps best suited for late stage reviews.

It should be noted that throughout this application reference has been made occasionally to an intermediary that acts between the do-it-yourself individual, entity or representative and the professional reviewer. Ultimately, the draft needs to reach the professional reviewer. An intermediary is not required, but if an intermediary is involved the intermediary can collect the required information and interface with the do-it-yourself individual, entity or representative and then transmit or otherwise send the draft to the professional reviewer. After this step the professional reviewer can then review the draft and/or edit the draft and either return it directly to the do-it-yourself individual, entity or representative, or simply return the draft to the intermediary who then could return the draft to the do-it-yourself individual, entity or representative. Of course, these processes could be repeated as necessary or desired to provide additional reviews. With subsequent reviews an intermediary may be used but is not required.

While the present invention has at times been described above in terms of specific embodiments, particularly in terms of the creation of and review of a patent application or provisional patent application, it is to be understood that the invention is not limited to the disclosed embodiments. This system, method and apparatus can be used to allow for the creation and/or review of any number of documents, including both business related documents and legal and other documents needed by individuals in a non-business context, such as wills, trusts, living wills, powers of attorney, divorce papers, bankruptcy papers, child custody papers, landlord-tenant contracts/documents, real estate agreements/documents and any other type of legal or professional document that may be encountered. In these and all other settings the invention would remain the same. A draft would be provided for professional review. The draft could be created by taking the answers to questions and inserting them into a template and then submitting the draft to the professional reviewer and/or an intermediary, as described above. The questions required to collect the required information would be different, as would the template, but the professional review would be largely the same. Certain the professional review would be looking for different mistakes and omissions depending up on the document and subject matter, but the method, system and apparatus would operate the same. With this in mind, the present invention is intended to cover various modifications and equivalent structures and methods included within the spirit and scope of the claims.

What I claim is:

1. A document creation and review method comprising:
providing a questionnaire to a do-it-yourself individual;
receiving the completed questionnaire with answers;
using the answers to completed questionnaire to create a first draft;
a trained professional reviewing the first draft and inserting comments;
the trained professional returning the first draft containing comments to the do-it-yourself individual.

2. The method of claim 1 wherein the reviewing step further includes the trained professional editing the first draft.

3. The method of claim 2 further comprising the step of the do-it-yourself individual editing the first draft to create a second draft.

4. The method of claim 3 further comprising the step of the do-it-yourself individual returning the second draft to the trained professional.

5. The method of claim 4 further comprising the step of the trained professional reviewing the second draft and inserting comments.

6. The method of claim 5 wherein the step of reviewing the second draft further includes the trained professional editing the second draft.

7. The method of claim 6 further comprising the step of the trained professional returning the second draft containing comments to the do-it-yourself individual.

8. The method of claim 7 further comprising the step of providing the do-it-yourself individual with filing instructions.

9. The method of claim 8 further comprising the step of providing the do-it-yourself individual with forms necessary for filing.

10. A document creation and review method comprising:
an intermediate providing a questionnaire to a do-it-yourself individual;
the intermediate receiving the completed questionnaire with answers;
the intermediate using the answers to completed questionnaire to create a first draft;
the intermediate giving the first draft to a trained professional;
the trained professional reviewing the first draft and inserting comments;
the trained professional returning the first draft containing comments to the intermediate.

11. The method of claim 10 further comprising the step of the intermediate giving the first draft to the do-it-yourself individual.

12. The method of claim 11 further comprising the step of the do-it-yourself individual editing the first draft to create a second draft.

13. The method of claim 12 further comprising the step of the do-it-yourself individual returning the second draft to the intermediate.

14. The method of claim 13 further comprising the step of the intermediate giving the second draft to the trained professional.

15. The method of claim 14 further comprising the step of the trained professional reviewing the second draft and inserting comments.

16. The method of claim 15 further comprising the step of the trained professional returning the second draft containing comments to the intermediate.

17. The method of claim 16 further comprising the step of providing the do-it-yourself individual with filing instructions.

18. The method of claim 17 further comprising the step of providing the do-it-yourself individual with forms necessary for filing.

19. The method of claim 18 further comprising the step of the trained professional editing the first draft.

20. The method of claim 19 further comprising the step of the trained professional editing the second draft.
